(19) United States
(12) Patent Application Publication
(10) Pub. No.: US 2025/0293771 A1
(43) Pub. Date: Sep. 18, 2025

(54) OPTICAL LINE PHYSICAL PARAMETERS CALIBATION IN PRESENCE OF EDFA TOTAL POWER MONITORS

(71) Applicant: NEC Laboratories America, Inc., Princeton, NJ (US)

(72) Inventor: Giacomo BORRACCINI, Plainsboro, NJ (US)

(73) Assignee: NEC Laboratories America, Inc., Princeton, NJ (US)

(21) Appl. No.: 18/901,852

(22) Filed: Sep. 30, 2024

Related U.S. Application Data
(60) Provisional application No. 63/564,058, filed on Mar. 12, 2024.
(60) Provisional application No. 63/649,607, filed on May 20, 2024.

(51) Int. Cl. H04B 10/077; H04B 10/079

(52) U.S. Cl. CPC H04B 10/0775; H04B 10/0773; H04B 10/0795

(57) ABSTRACT

Disclosed is a methodology for calibrating model physical parameters of an optical line after its installation using EDFA-integrated total power monitors and a single OSA at the receiver, improving QoT and margin estimation.

### CROSS-REFERENCE TO RELATED APPLICATIONS

This application claims the benefit of U.S. Provisional Patent Application Ser. No. 63/564,058 filed Mar. 12, 2024, and Untied States Provisional Patent Application Ser. No. 63/649,607 filed May 20, 2024, the entire contents of each of which is incorporated by reference as if set forth at length herein.

### FIELD OF THE INVENTION

This application relates generally to optical networking. More particularly, it pertains to optical line physical parameters calibration in presence of Erbium-doped fiber amplifier (EDFA) total power monitors.

### BACKGROUND OF THE INVENTION

In optical fiber networks, the deployment of a generic transparent light-path (LP) between nodes of a given network is based on two crucial aspects in the management and control of the infrastructure at the physical layer. Those crucial aspects are quality-of-transmission estimation (QoT-E) and a definition of operative margins.

An accurate estimation of the latter allows one to define the highest bit rate for each LP, avoiding waste of capacity when satisfying upcoming traffic requests. As it turns out, QoT and margins estimation are challenging in cases of multi-span optical lines having only photodiodes available integrated in each erbium-doped fiber amplifier (EDFA), monitoring the total optical power.

### SUMMARY OF THE INVENTION

An advance in the art is made according to aspects of the present disclosure directed to a methodology for calibrating model physical parameters of an optical line after its installation using EDFA-integrated total power monitors and a single OSA at the receiver, improving QoT and margin estimation.

In sharp contrast to the prior art and according to aspects of the present disclosure, an inventive procedure according to the present disclosure retrieves the physical characteristics of both EDFAs and optical fibers without any device pre-characterization, instead only knowing EDFA operational ranges (amplification band limits, total power, gain and tilt). Then, the procedure exploits a minimal number of pre-defined measurements, each one measuring the system in a different specific configuration of EDFA target parameters by using all total power monitors and an optical spectrum analyzer (OSA) at the line termination. Furthermore, it can be adapted and made more robust exploiting even other monitors, such as OCMs, probing transceivers or optical time domain reflectometers (OTDRs) to increment the available physical layer information.

Viewed from one aspect, our inventive procedure accurately performs QoT and margin estimation related to their impact on optical transmission, enabling a planning tool within a network controller to be reliable and providing improvement of multiple tasks, such as optical line optimization, tomography and LP computation engine (L-PCE).

Broadly viewed from another aspect, Given a digital physical layer model for EDFAs and optical fibers, our inventive procedure allows one to retrieve needed physical parameters to reproduce measured behavior of a system in terms of optical signal-to-noise ratio (OSNR). The procedure broadly proceeds according to two consecutive steps, namely:
datasets acquisition, fixing once the input spectrum—the total power at the booster input is designed as the difference between its maximum output power and maximum gain, allowing to swipe along the whole dynamics of the booster—and changing the configuration of EDFAs; and
calibration (optimization) of the physical parameters of the digital model to match between simulated metrics (signal or ASE noise power) and the measures considering the same working condition.

Viewed from yet another aspect, our inventive procedure includes a design of measurement type and choice that enables the effective solution to the problem. In this regard, each measurement is defined in order to characterize a specific physical parameter within the digital model simulating the optical propagation under different working conditions of the EDFAs. For at least this reason, the procedure defines a minimal number of measurements, targeting to entirely calibrate the optical line with the minimum number of necessary measurements.

### BRIEF DESCRIPTION OF THE DRAWING

FIG. 1 is a schematic flow diagram showing an illustrative datasets acquisition and parameters calibration according to aspects of the present disclosure.

FIG. 2(A), FIG. 2(B), and FIG. 2(C) show: FIG. 2(A) experimental laboratory transmission arrangement having 5 EDF-amplified standard single-mode fiber (SSMF) spans with an ASE noise source filtered by multiplexer at the transmitter ad an OSA at the receiver terminal, FIG. 2(B) plot of total measured output power for each configuration comprising a fiber dataset and, FIG. 2(C) a 3D representation of the noise figure dataset configurations according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

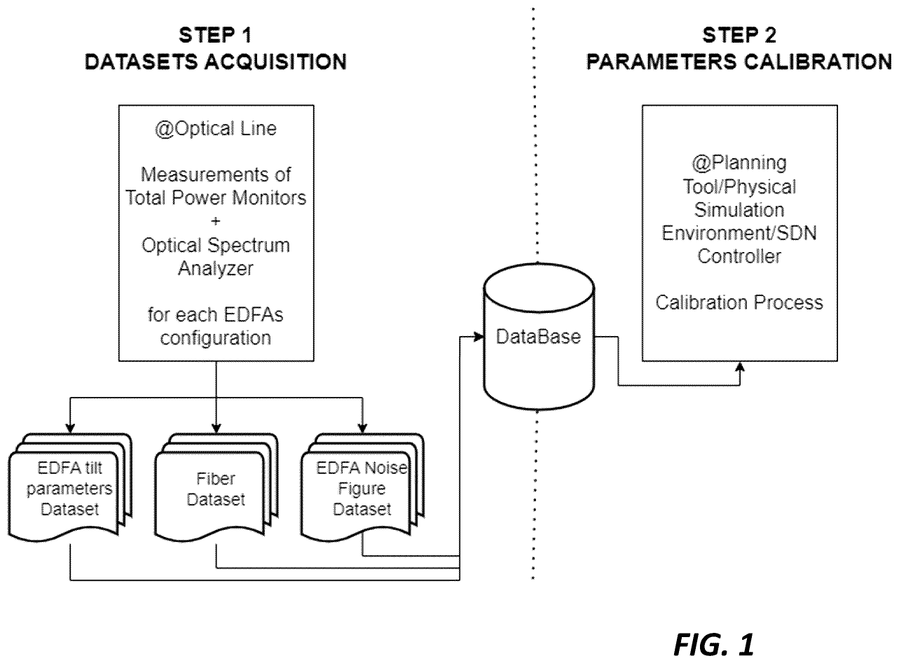

FIG. 1 is a schematic flow diagram showing an illustrative datasets acquisition and parameters calibration according to aspects of the present disclosure.

With reference to that figure, it may be observed that datasets including measurements of total power monitors, optical spectrum analyzer for each EDFA configuration are collected in datasets and stored in a database. Those stored datasets are then used for parameter calibration by our inventive methods and procedures.

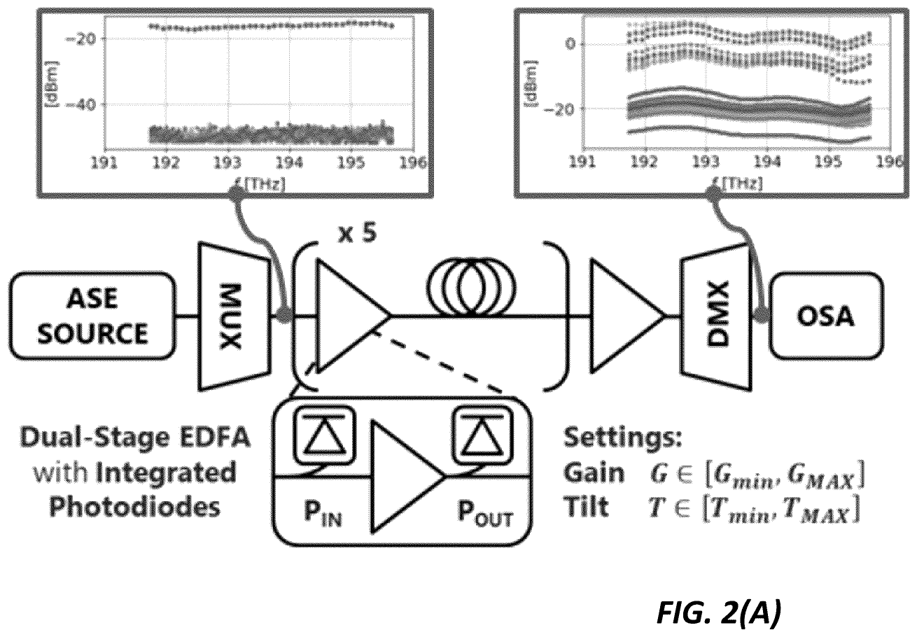

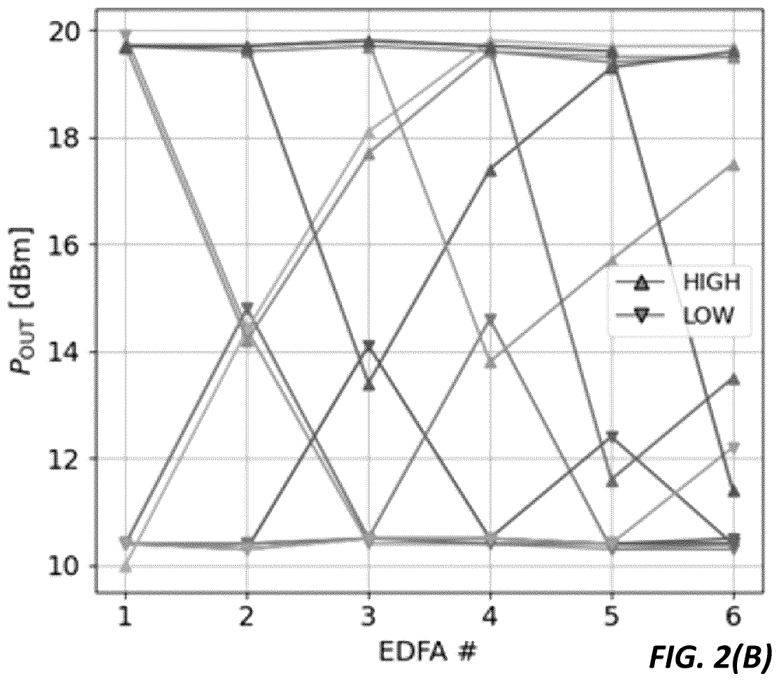

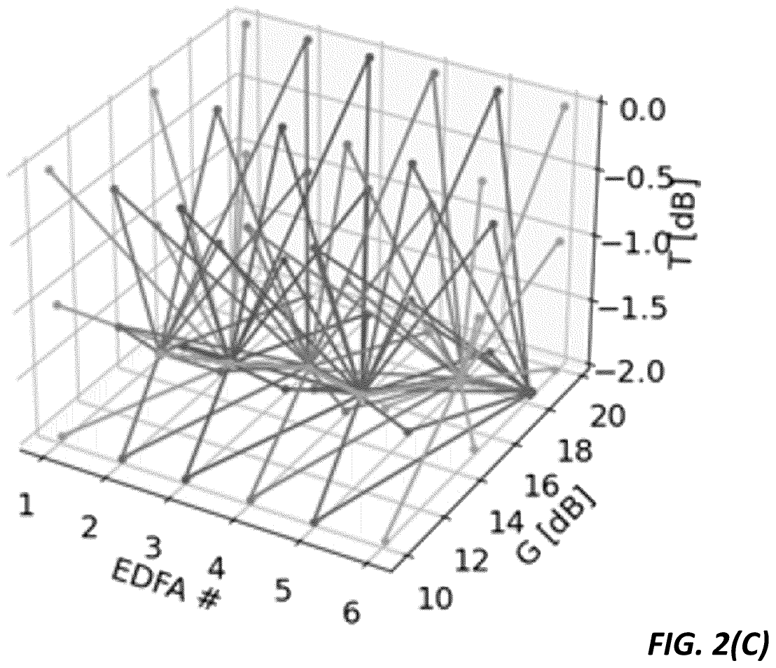

FIG. 2(A), FIG. 2(B), and FIG. 2(C) show: FIG. 2(A) experimental laboratory transmission arrangement having 5 EDF-amplified standard single-mode fiber (SSMF) spans with an ASE noise source filtered by multiplexer at the transmitter ad an OSA at the receiver terminal, FIG. 2(B) plot of total measured output power for each configuration comprising a fiber dataset and, FIG. 2(C) a 3D representation of the noise figure dataset configurations according to aspects of the present disclosure.

As illustrated in FIG. 2(A), an experimental transmission arrangement employed is a multi-span EDF-amplified optical link between two adjacent reconfigurable optical add-drop multiplexers (ROADMs) within a given optical network where each EDFA has integrated total power monitors at each terminal.

A calibration procedure according to the present disclosure is based on the following requirements:

EDFAs are dual-stage amplifiers and provide automatic gain control (AGC), setting both gain and tilt as target parameters.

The procedure is performed after the installation of the cable and before the beginning of networking operations.

Additional equipment needed includes an amplified spontaneous emission (ASE) source, generating a full channel load at the transmitter, and an optical spectrum analyzer (OSA), measuring the spectrum at the receiver.

The procedure requires the use of an input propagating spectrum with every other channel, generated by means of the ROADM wavelength selective switch (WSS) to measure both the channel and ASE noise power—i.e., 40˜active channels in 50˜GHz full C-band grid.

Considering a certain EDFAs working point configuration of gain and tilt targets, a single optical line measurement consists of the set of EDFA monitoring information and OSA measurement. The latter is post-processed to obtain the signal and ASE power profiles at the receiver.

Those skilled in the art will understand and appreciate that one objective of the first step is to locally change the properties of each device—gain ripple profile and noise figure for EDFAs, or stimulated Raman scattering (SRS) for optical fibers—modifying the working point of the EDFAs and measuring the accumulation of the effects using the OSA.

First, the optical line is set in transparency configuration, where each EDFA recovers the loss introduced by the previous span. If not specified, all EDFAs are set at the same tilt value making flat the spectrum profile at the receiver for the set booster gain.

Three different datasets are collected focused on the calibration of different groups of physical parameters for each fiber span. The creation of each dataset originates from the transparency configuration at an arbitrary launch power imposed by the booster gain and each measured line configuration is based on the variation of a single EDFA target parameter.

The first dataset regards the tilt parameters of EDFAs, and it is collected setting the booster at the minimum gain, all EDFAs at 0˜dB tilt and, for each configuration, moving a single EDFA at the minimum tilt (with respect to wavelength).

The second dataset, FIG. 2(B), focuses on the SRS of optical fibers and is built performing two sequences of line measurements, setting the booster at minimum/maximum gain, where a single EDFA is set to the maximum/minimum gain in order to locally enhance/reduce the SRS effect.

The last dataset, FIG. 2(C), involves the calibration of EDFA noise figure parameters and, setting the booster at the gain dynamics center, a single EDFA gain, and tilt parameter is changed per configuration, sampling the specific OSNR condition.

The total number of measurements for each dataset is 1+N_{EDFA}, 2*N_{EDFA} and n_{G}*n_{T}*N_{EDFA}, respectively, where N_{EDFA} is the number of EDFAs along the line, n_{G} and n_{T} are the chosen numbers of gain and tilt values defining the granularity of the third dataset. As shown in FIG. 3(C), each 3D profile is a configuration, and a color is assigned to each bunch of configurations changing a specific EDFA.

The second step involves the use of the second and third datasets and aims to jointly calibrate the physical model parameters of each device throughout a training process by means of an optimization algorithm. Simulating the scenario in the same working condition of each considered configuration per each extracted set of physical layer parameters and defining the error operator, Δ, as the difference between the measured data and the simulated metrics, the following cost function is minimized according to the following:

$${min}_{\{ x \}} f ( x ) = \frac{1}{{N}_{CONF}} {\sum }_{i}^{{N}_{CONF}} [ {σ}_{Δ {P}_{SIG ; i}^{dB}} + \vert Δ \overline{{OSNR}_{i}^{dB}} \vert ] + {σ}_{Δ \overline{{OSNR}_{i}^{dB}}}$$

where x is the set of parameters to calibrate, N_{CONF} is the total number of configurations, σ_{ΔP}dBSIG is the standard deviation of the signal power error profile, |ΔOSNR^{dB}ᵢ| is the absolute error of the OSNR profile average and σΔOSNR_{dBi} is the standard deviation of the OSNR profile average error.

First, the EDFA tilt parameters are analytically derived from the first dataset. The second and third datasets are involved in the training phase, calibrating 8 parameters for each fiber span—related to the loss coefficient function, Raman gain coefficient and connector losses—and other 4 for each EDFA noise figure function. The total accumulated gain ripple profile is estimated by difference with the model assuming that all EDFAs have the same profile. Furthermore, the noise figure is assumed flat in frequency and modelled with a convex parabola, depending on both gain and tilt parameters.

The resulting optical line calibrated physical model (64 parameters) is tested against two other datasets, each of 100 random EDFA gain and tilt configurations, and compared with a base-line model at an optimal working point configuration. The first dataset is collected introducing every other channel spectrum (40 channels), while the second one in full spectral load condition (80 channels).

The accuracy of the model as compared to the test measurements of the first dataset of the order of approximately 0.1 dB and 0.2 dB respectively for the signal ripple and OSNR with a slight bias on the distributions of the means. The signal can be easily corrected by exploiting the information from the EDFAs monitors.

Doubling the number of channels showed that the same degree of accuracy is maintained when looking at channel power error metrics (in this case, signal power and ASE noise). A base-line model for the transmission scenario shown is then created assuming a fixed connector loss and noise figure value and tuning a flat loss coefficient according to the span losses measured by power monitors. The estimation of the received signal power and OSNR are performed for the central channel.

Using this model, the optical line working point is optimized at full spectral load condition following the local optimization global optimization (LOGO) strategy using scalar values and conventional SSMF fiber parameters values, and the OSNR is measured in 8 spectral slots switching off one channel per time. The comparison between the two models on the estimation of the signal and OSNR error profiles clarifies the difference of the margin to be designed in terms of order of magnitude.

It is important to note a bias of roughly 1 dB, although conservative, in the ASE power profile estimated from the comparison between the measured data and the calibrated model, attributable to a lower noise figure value due to the higher number of channels compared to the spectrum configuration being calibrated.

A methodology calibrating model physical parameters for an optical line equipped with total power monitors only is described and experimentally tested, aiming to improve QoT-E and control. The limitations to be noted concern the difficult scalability due to the high number of variables involved, the training time and possible shadowing phenomena due to the observational approach of end-of-line accumulation. They can be overcome by improving the model, taking better precautions during the training phase and increasing the information coming from the monitoring devices, also opening the possibility of carrying out optical line tomography based on the recognition of physical parameters.

While we have presented our inventive concepts and description using specific examples, our invention is not so limited. Accordingly, the scope of our invention should be considered in view of the following claims.

1. A method for calibrating physical parameters of a multi-span, erbium-doped fiber (EDF) amplified (EDFA) optical link of an optical network, the method comprising:
locally change properties of each device in the multi-span, EDF amplified optical network;
create three different datasets for each optical link of the optical network, the first dataset including tilt parameters of EDFAs, the second dataset including stimulated Raman scattering (SRS) of optical fibers, and the third dataset including EDFA noise figure parameters; and
using the second and third datasets, jointly calibrating physical model parameters of each device;
wherein the optical link of the optical network is only equipped with EDFA integrated total power monitors comprising photodiodes at each EDFA.

2. The method of claim 1 wherein the EDFAs are dual-stage amplifiers that provide automatic gain control (AGC) and set both gain and tilt as target parameters.

3. The method of claim 2 wherein the locally changed properties of each device include gain ripple profile and noise figure for EDFAs, and SRS for optical fibers, and modifying working points for EDFAs and measuring accumulation of effects using optical spectrum analysis (OSA).

4. The method of claim 3 in which all optical links of the optical network are set to a transparency configuration in which all EDFAs are set at a same tilt value such that a spectrum profile is flat for a set booster gain.

5. The method of claim 4 in which the first dataset is collected after setting booster at a minimum gain, all EDFAs at 0 dB tilt.

6. The method of claim 5 in which the second dataset is collected after setting a single EDFA is set to affect SRS effect.

7. The method of claim 6 in which the third dataset is collected after setting the booster at a gain dynamic center, a single EDFA gain, and tilt parameter is changed per configuration while sampling a specific optical signal to noise ratio (OSNR) condition.

8. The method of claim 7 in which a total number of measurements for each dataset is 1+N_{EDFA}, 2*N_{EDFA} and n_{G}*n_{T}*N_{EDFA}, respectively, where N_{EDFA} is the number of EDFAs along an optical link, n_{G} and n_{T} are chosen numbers of gain and tilt values defining a granularity of the third dataset.
